(19) United States
(12) Patent Application Publication
(10) Pub. No.: US 2026/0307596 A1
(43) Pub. Date: Oct. 8, 2026

(54) TELESCOPIC TRAILER BOTTOM INSPECTION DEVICE

(71) Applicant: Torc Robotics, Inc., Blacksburg, VA (US)

(72) Inventor: Fridtjof Stein, Ostfildern (DE)

(21) Appl. No.: 19/172,156

(22) Filed: Apr. 7, 2025

(51) Int. Cl. B60R 11/04; B60R 16/023

(52) U.S. Cl. CPC B60R 11/04; B60R 16/023; B60R 2300/101; B60R 2300/602; B60R 2300/8093

(57) ABSTRACT

A remote imaging system of an autonomous vehicle enables imaging and interpretation of a volume of interest underneath a trailer (where the trailer is attached to the autonomous vehicle). The remote imaging system can include a remote imaging device which is positioned along a truck bed of the autonomous vehicle for extension beyond the truck bed and into the volume of interest underneath the trailer. The remote imaging device can include a telescoping probe member in operative association with linear and rotational actuators, in addition to a sensor device which can capture imaging data of the volume of interest. Imaging data captured by the remote imaging device may be interpreted by a perception and understanding module of an autonomy computing system of the autonomous vehicle.

### TECHNICAL FIELD

The field of the disclosure relates generally to autonomous vehicles and, more specifically, to a remote inspection device for inspecting a space underneath a trailer connected to an autonomous vehicle.

### BACKGROUND OF THE INVENTION

According to traffic regulations, drivers are required to perform a departure check. Additionally, truck driver training emphasizes the need to watch for children and other hazards around a truck that may be difficult to see, particularly when the truck is attached to a trailer. The same applies to autonomous vehicles.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In some aspects, the techniques described herein relate to a remote imaging device, including: a telescoping probe member in operative communication with a control device, the telescoping probe member including: a proximal portion coupled to a rear portion of an autonomous vehicle; and a distal portion having a sensor device operable to capture imaging data for a volume of interest underneath a trailer when the trailer is coupled to the rear portion of the autonomous vehicle; wherein the distal portion of the telescoping probe member is movable between a stowed configuration and an extended configuration by a linear actuator device in operative communication with the control device.

In some aspects, the techniques described herein relate to a method of conducting a pre-departure check of a volume of interest, including: applying, by a computing device of an autonomous vehicle, one or more linear control signals to a linear actuator device of a remote imaging device that transitions a telescoping probe member of the remote imaging device between a stowed configuration and an extended configuration; capturing, by a sensor device positioned at a distal portion of the telescoping probe member, imaging data for a volume of interest underneath a trailer coupled to the autonomous vehicle; and communicating the imaging data for the volume of interest to a perception and understanding module of an autonomy computing system of the autonomous vehicle.

In some aspects, the techniques described herein relate to a computing system of an autonomous vehicle, including: a processor in communication with a memory, the memory including instructions executable by the processor to: apply one or more linear control signals to a linear actuator device of a remote imaging device that transitions a telescoping probe member of the remote imaging device between a stowed configuration and an extended configuration, the remote imaging device having an exterior encapsulating lumen coupled to a rear portion of the autonomous vehicle; capture, by a sensor device positioned at a distal portion of the telescoping probe member, imaging data for a volume of interest underneath a trailer coupled to an autonomous vehicle; and communicate the imaging data for the volume of interest to a perception and understanding module of an autonomy computing system of the autonomous vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1A is an illustration showing an example autonomous vehicle;

FIG. 1B is an illustration showing a side view of the autonomous vehicle of FIG. 1A coupled with a trailer;

FIG. 2 is a block diagram of the autonomous vehicle shown in FIG. 1A;

FIG. 3 is a block diagram of an example computing system for implementation of aspects of the autonomous vehicle of FIG. 1A;

FIG. 4A is an illustration showing an example remote imaging system for an autonomous vehicle;

FIG. 4B is a block diagram of the remote imaging system shown in FIG. 4A;

FIG. 5A is an illustration showing the remote imaging device of FIGS. 4A and 4B in a “stowed” configuration;

FIG. 5B is an illustration showing the remote imaging device of FIG. 5A in a (partially) extended position;

FIG. 5C is an illustration showing the remote imaging device of FIG. 5A in a (fully) extended position;

FIGS. 6A and 6B are a pair of illustrations respectively showing side and bottom views of the remote imaging device of FIG. 5A in the “stowed” configuration, in context with the autonomous vehicle and trailer of FIG. 1B;

FIGS. 6C and 6D are a pair of illustrations respectively showing side and bottom views of the remote imaging device of FIG. 5B in the (partially) extended position, in context with the autonomous vehicle and trailer of FIG. 1B;

FIGS. 6E and 6F are a pair of illustrations respectively showing side and bottom views of the remote imaging device of FIG. 5C in the (fully) extended position, in context with the autonomous vehicle and trailer of FIG. 1B;

FIGS. 7A and 7B are a pair of illustrations showing a rotational aspect of the remote imaging device of FIGS. 4A and 4B, where FIG. 7A shows the remote imaging device including a rotational actuator in the (partially) extended position and where FIG. 7B shows the remote imaging device including a rotational actuator in an extended (and rotated) position;

FIGS. 8A and 8B are a pair of illustrations showing the remote imaging device of FIGS. 7A and 7B in context with the autonomous vehicle and trailer of FIG. 1B, where FIG. 8A shows a rotation of a first segment of the remote imaging device and FIG. 8B shows additional rotation of a second segment of the remote imaging device;

FIGS. 9A and 9B are a pair of illustrations showing an example support member of the remote imaging device of FIG. 5C, including a first “stowed” position and a second “deployed” position of the remote imaging device; and

FIG. 10 is a flow diagram of an example method of conducting a departure check that can be implemented using the systems of FIGS. 1A-9B.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

For autonomous trucks, it is essential to ensure at departure that an area around a truck is clear, which may be difficult using existing perception technologies when the truck is attached to a trailer. In real-world implementation, autonomous trucks often pull trailers having no supporting sensors to aid perception by the autonomous truck. As such, the present disclosure is directed to a remote under-trailer imaging system for an autonomous vehicle that enables the autonomous vehicle to view and perceive information about an area underneath a trailer. The systems outlined herein may be employed by an autonomous vehicle to determine whether an area underneath a trailer is clear of individuals, debris, curbs, and the like during a departure check. Alternatively or in addition, the systems outlined herein may be employed to check tire status and/or check for irregularities such as damage or tampering.

### Autonomous Vehicle Overview

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

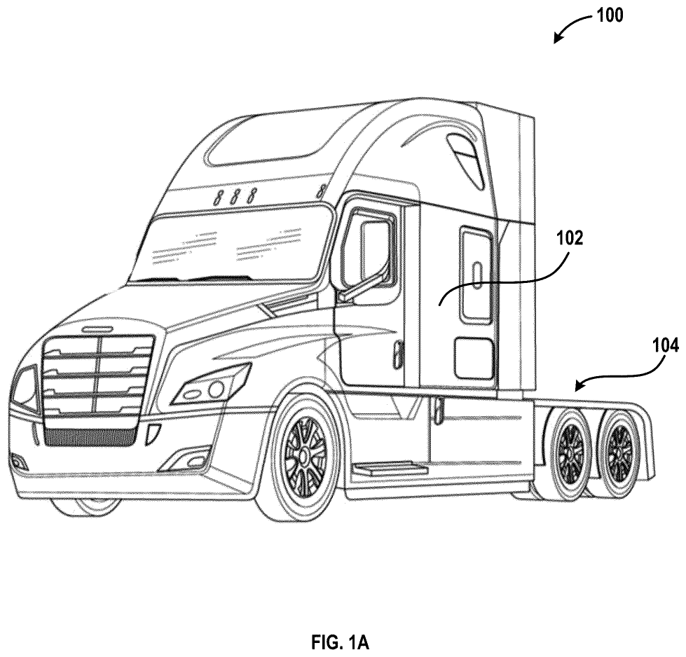

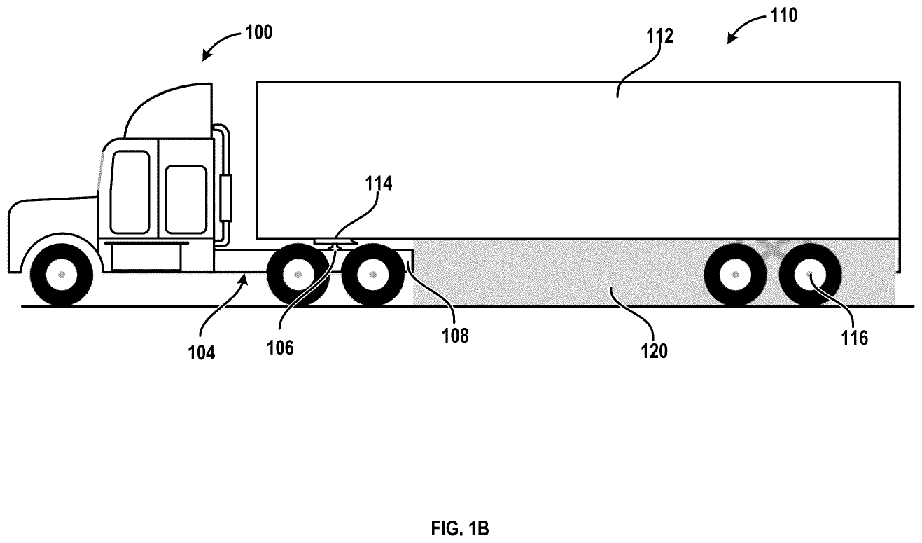

FIG. 1A illustrates an autonomous vehicle 100, such as a truck that may be conventionally connected to a single or tandem trailer to transport the trailer (FIG. 1B) to a desired location. The autonomous vehicle 100 includes a cabin 102 that can be supported by, and steered in the required direction, by front wheels and rear wheels that are partially shown in FIG. 1A. Front wheels are positioned by a steering system that includes a steering wheel and a steering column (not shown in FIG. 1A). The steering wheel and the steering column may be located in the interior of cabin 102.

The autonomous vehicle 100 may be an autonomous vehicle, in which case the autonomous vehicle 100 may omit the steering wheel and the steering column to steer the autonomous vehicle 100. Rather, the autonomous vehicle 100 may be operated by an autonomy computing system (not shown) of the vehicle 100 based on data collected by a sensor network (not shown in FIG. 1A) including one or more sensors.

As shown, with additional reference to FIG. 1B, the autonomous vehicle 100 can include a truck bed 104 behind the cabin 102, which may include a hitch element 106 for engagement with a trailer. The truck bed 104 can further define a rear portion 108 that can be behind the hitch element 106 as shown.

FIG. 1B illustrates a side view of the autonomous vehicle 100 of FIG. 1A coupled with a trailer 110. The trailer 110 may be a common non-autonomous trailer that may not include sensors capable of interfacing with the autonomous vehicle for perception. The trailer 110 can include a trailer body 112 that may be coupled with the hitch element 106 of the vehicle 100 at a kingpin 114, and can further include at least one rear axle 116 having wheels (often four total, two on each side) coupled to the rear axle 116. FIG. 1B also shows a volume of interest 120 underneath the trailer 110, denoted in FIG. 1B shaded in gray.

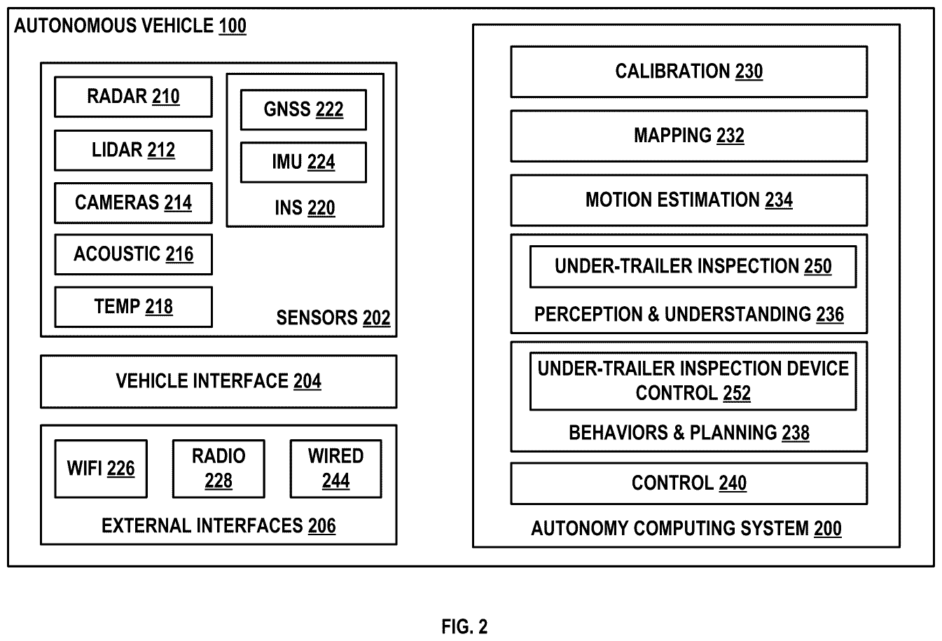

FIG. 2 is a block diagram of autonomous vehicle 100 shown in FIGS. 1A and 1B. In the example embodiment, autonomous vehicle 100 includes an autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or a hub or both.

Further, sensors 202 may include a sensor device of a remote imaging device outlined herein for capturing imaging data of an area underneath a trailer (e.g., trailer 110 shown in FIG. 1B) when the trailer is coupled to the truck bed (e.g., truck bed 104 shown in FIG. 1B) of the autonomous vehicle 100. The sensor device of the remote imaging device can include a camera, such as camera 214, for capturing still-image or video data; the camera may be capable of capturing long-wave infrared (IR) image(s) for evaluating tire, axle, and/or brake temperature. In some examples, the sensor device of the remote imaging device can capture image data in a wide-angle or “fisheye” view to maximize a field of view.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a “perception and understanding” module 236 which may encompass an under-trailer inspection module 250 that interfaces with a remote imaging device outlined herein, a “behaviors and planning” module 238 which may encompass an under-trailer inspection device control module 252 that interfaces with a remote imaging device outlined herein, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The under-trailer inspection module 250 may perform one or more tasks including, but not limited to: accessing image data captured by a sensor device of a remote imaging device outlined herein; and interpreting, as part of a departure check protocol of the autonomous vehicle, the image data to identify any obstacles or irregularities. Based on the image data, the autonomy computing system 200 may or may not allow the autonomous vehicle 100 to depart. In some examples, the under-trailer inspection module 250 may determine whether image data should be sent to a backend device for review by a human or other authority before the autonomous vehicle 100 is allowed to depart.

The under-trailer inspection device control module 252 may perform one or more tasks including, but not limited to: apply one or more control signals to an electronic control unit associated with a remote imaging device that instruct one or more actuators of the remote imaging device to transition between a “stowed” configuration and an “extended” configuration (which may be one of a plurality of “extended” configurations varying in length and/or angle); and/or apply one or more control signals to an electronic control unit associated with a remote imaging device that instruct one or more rotational actuators of the remote imaging device to transition between a “stowed” configuration or a first “extended” configuration and a second “extended” configuration (e.g., “bending” a telescoping member of the remote imaging device to view confined spaces such as between axles as outlined below).

In some examples, the under-trailer inspection device control module 252 may: identify a trailer angle at which a direction of elongation of a trailer may be angled relative to a direction of elongation of the autonomous vehicle 100; and apply one or more control signals to an electronic control unit associated with a remote imaging device that instruct one or more rotational actuators of the remote imaging device to transition between a “stowed” configuration or a first “extended” configuration and a second “extended” configuration (e.g., to “bend” a telescoping member of the remote imaging device) based on the trailer angle.

The under-trailer inspection device control module 252 may further apply one or more control signals to an electronic control unit associated with a remote imaging device that instruct a sensor device of the remote imaging device to capture imaging data.

In a further aspect, the under-trailer inspection device control module 252 may apply one or more control signals to an electronic control unit associated with a remote imaging device that actuate additional components of the remote imaging device, including but not limited to: one or more protective caps and/or a support member.

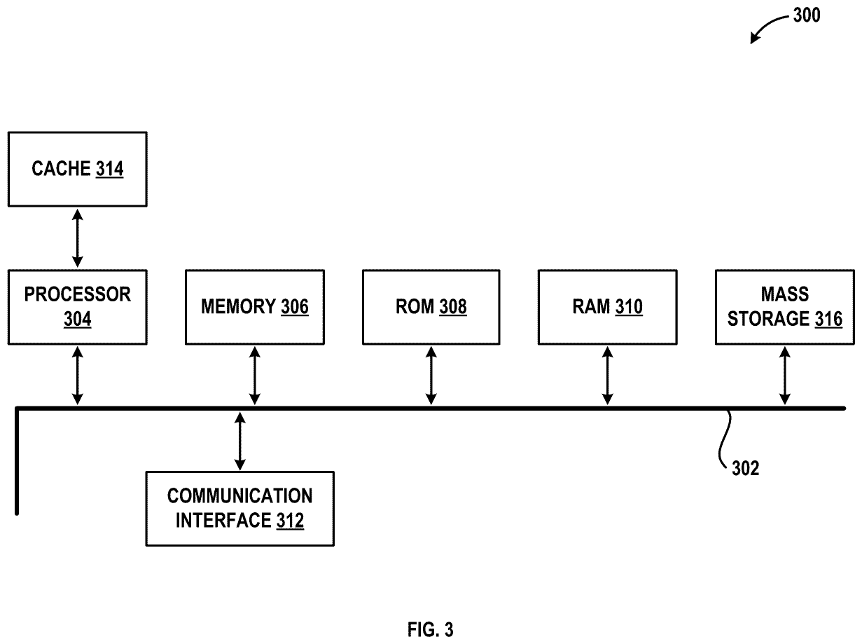

FIG. 3 illustrates an example computing system 300 that can implement various techniques, processes, functions, or methods described herein. The components of computing system 300 are shown in electrical communication with each other using a communication bus 302. The example computing system 300 includes a processor (CPU or processing unit) 304 coupled with communication bus 302 that couples various additional components to processor 304, including a memory 306, a read only memory (ROM) 308, and a random access memory (RAM) 310, and at least one communication interface 312. Communication interface 312 may include one or more additional components, such as integrated circuits, transceivers, transmitters, receivers, controllers, etc., for transmitting or receiving data over a channel. Such channels may include wired channels such as a serial channel, CAN bus, Ethernet or the like, or wireless channels employing protocols such as WiFi, Bluetooth, NFC, or other suitable wireless technologies.

In certain embodiments, as shown in FIG. 3, computing system 300 includes a cache 314 of high-speed memory connected directly with, in close proximity to, or integrated as part of processor 304. Computing system 300, in certain implementations, may copy data from memory 306 and/or a mass storage 316, also coupled with communication bus 302, to cache 314 for quick access by processor 304. In this way, cache 314 can improve performance of computing system 300 by reducing delays in processor 304 reading or writing data. These and other modules can store machine executable instructions for controlling, or configuring, processor 304 to perform various actions. Memory 306 can include multiple different types of memory with different performance characteristics. Processor 304 can include any general purpose processor, central processing unit (CPU), or graphics processing unit (GPU) in combination with a hardware or software provision configured to control processor 304. Such a software provision may be stored in memory 306, ROM 308, RAM 310, or mass storage 316. Processor 304 may, in certain embodiments, include a special-purpose processor where software instructions are incorporated into the processor design. Processor 304 may be a self-contained system, containing multiple cores or processors, a bus, memory controller, cache, etc. A multi-core processor may be symmetric or asymmetric.

Mass storage 316 is a non-volatile memory and can be one or more of a hard disk or other types of computer readable media that can store data that are accessible by a computer, such as a magnetic cassette, flash memory card, solid state memory device, digital versatile disk, cartridge, RAM, ROM, or hybrids thereof. Memory 306 or mass storage 316 can include machine executable instructions, software, code, firmware, etc., for controlling processor 304. In certain embodiments, processor 304 may be programmed, or configured, by encoding an operation or function using one or more machine executable instructions and providing the executable instructions in, for example, memory 306, ROM 308, RAM 310, or mass storage 316.

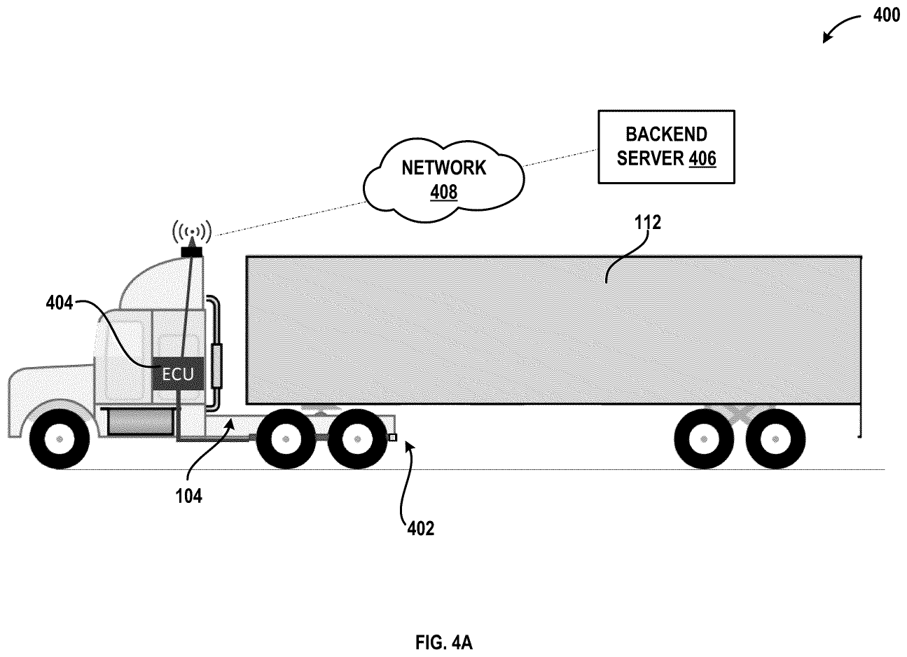

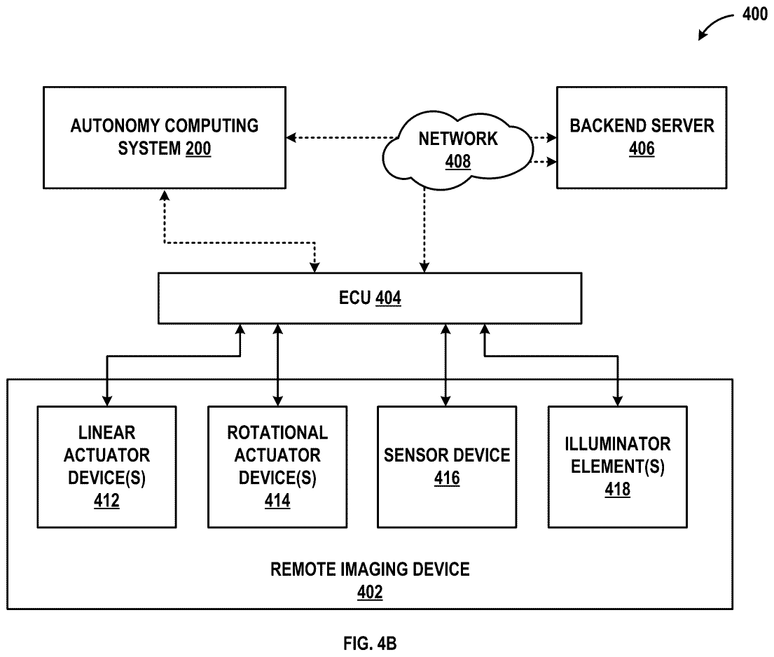

FIGS. 4A and 4B show a remote imaging system 400 for imaging a volume of interest underneath a trailer 110 (where the trailer 110 is attached to the autonomous vehicle 100). The remote imaging system 400 can include a remote imaging device 402 in communication with an electronic control unit (ECU) 404 that controls actuation of various components of the remote imaging device 402. The remote imaging device 402 is positioned along the truck bed 104 of the autonomous vehicle 100 for extension beyond the truck bed and into the volume of interest underneath the trailer 110. FIG. 4A illustrates a first diagram showing the remote imaging device 402 and the ECU 404 in the context of the autonomous vehicle 100. FIG. 4B illustrates a schematic diagram showing connection of the ECU 404 with components of the remote imaging device 402 and external components, as outlined further herein.

The ECU 404 can be a local controller device integrated with the autonomy computing system 200 as outlined above, particularly with respect to under-trailer inspection module 250 and/or under-trailer inspection device control module 252, which provide control inputs to the ECU 404. Under-trailer inspection module 250 interprets imaging data captured by a sensor device of the remote imaging device 402 for perception of the area of interest. The ECU 404 can further supply power and/or control inputs to various actuating components of the remote imaging device 402 in addition to the sensor device. The sensor device of the remote imaging device 402 may be considered one of the sensors 202 shown in FIG. 2, and captures imaging data that can be interpreted by the perception and understanding module 236. Behaviors and planning module 238 may use the imaging data and associated interpretation to control or otherwise plan behaviors of the autonomous vehicle 100. The ECU 404 may also generate error data if a problem with the remote imaging system 400 is detected (e.g., a mechanical or electrical problem, sensor failure).

In a further aspect, the ECU 404 may directly or indirectly communicate (e.g., through external interface(s) 206 of FIG. 2) with a backend server 406 over a network 408. FIG. 4A shows a first example where the ECU 404 communicates with the backend server 406 directly over network 408. Network 408 may include a wireless communication protocol such as, but not limited to, cellular (5G/4G/3G/LTE), Wi-Fi, radio, satellite, and the like. As shown in FIG. 4B, the ECU 404 may, alternatively or in addition, communicate locally to the autonomy computing system 200, which can interpret imaging data, error data, and other information as needed. In situations where a network connection with the backend server 406 is poor (e.g., in a tunnel, isolated and/or mountainous area, in the event of a communication network failure or excessive network traffic, etc.), the ECU 404 and/or autonomy computing system 200 may adjust the information being provided to the backend server 406 by, for example, sending “keyframe images” rather than a full video captured by the remote imaging system 400.

FIG. 4B shows communication between the ECU 404 and various components of the remote imaging device 402, including but not limited to: a linear actuator device 412, a rotational actuator device 414, and/or a sensor device 416 (which may be part of sensor(s) 202 including camera 214 of FIG. 2).

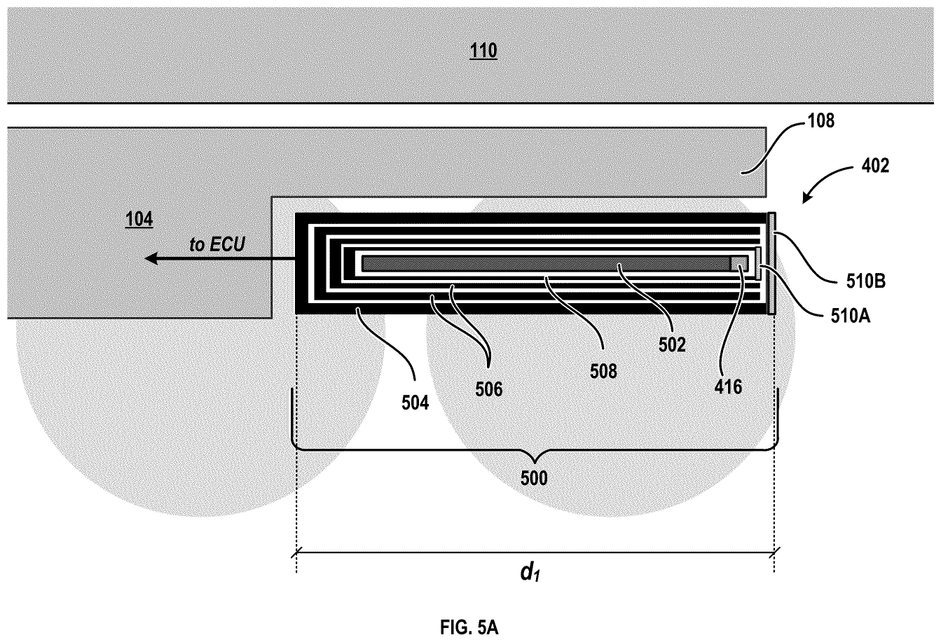

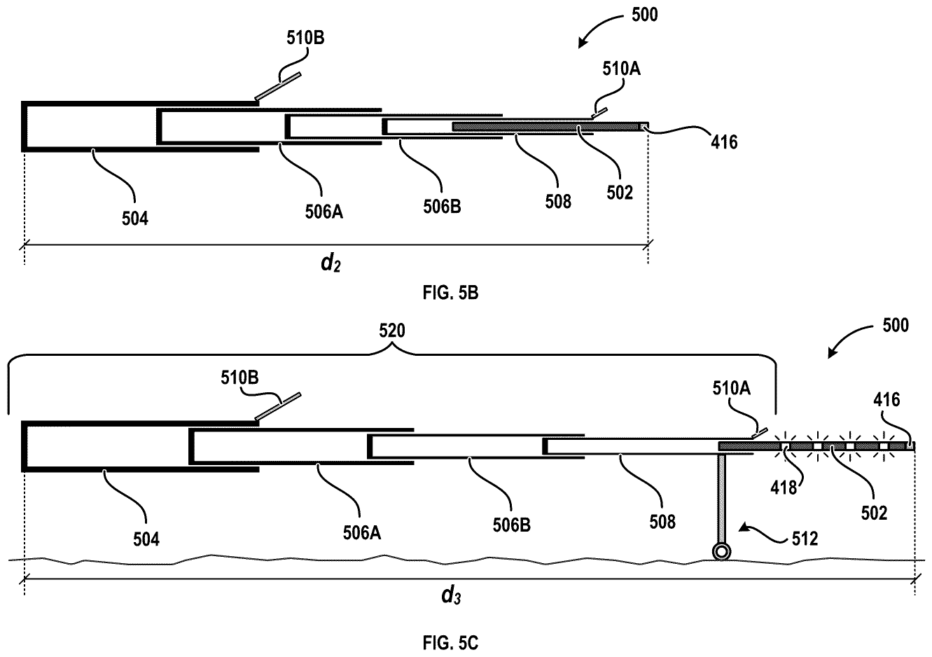

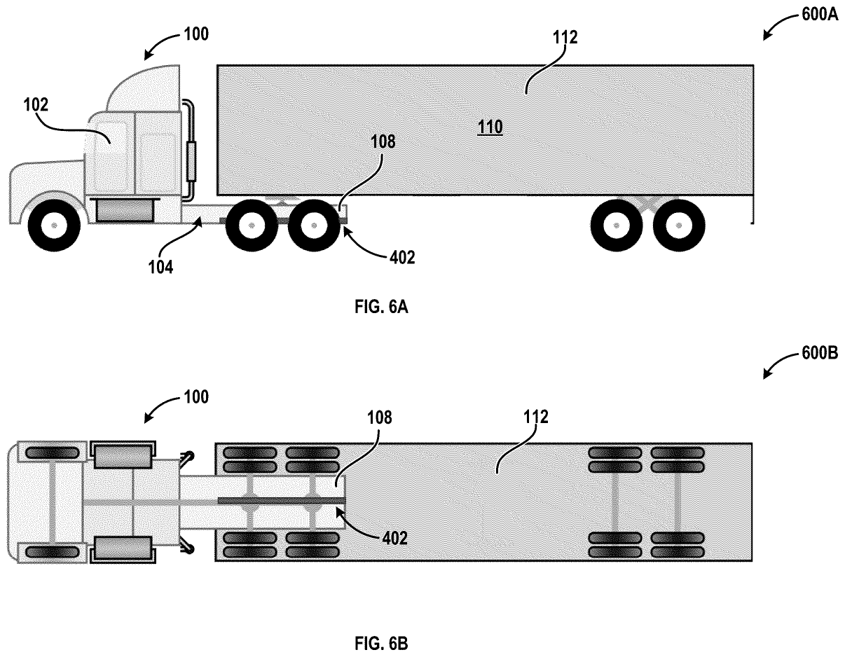

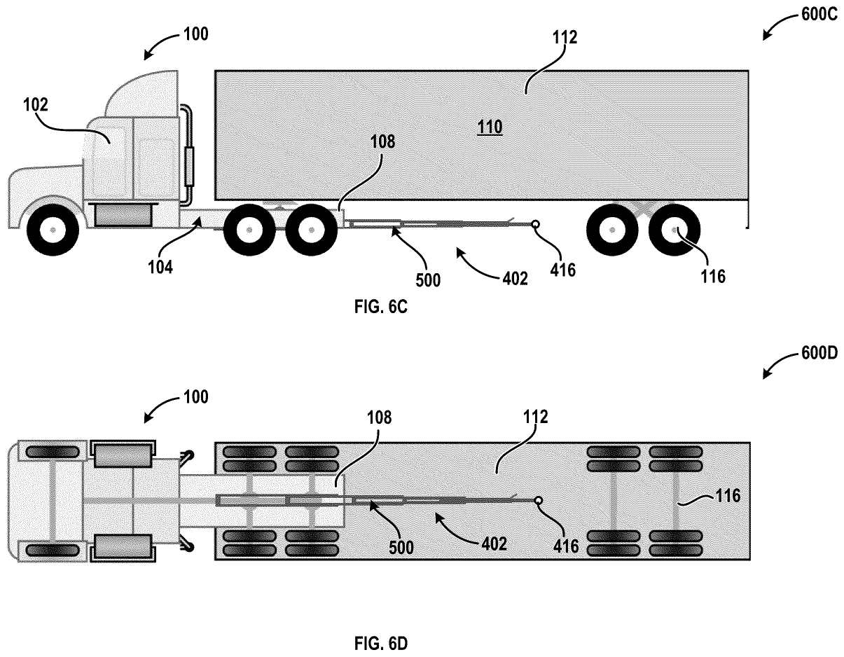

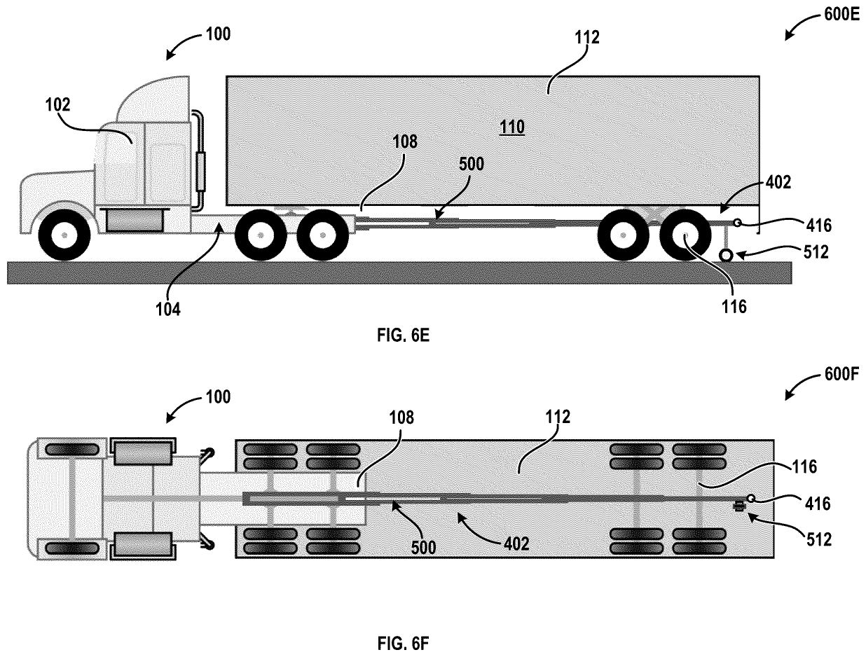

As outlined in further detail herein, the ECU 404 can generate or otherwise apply one or more linear control signals to the linear actuator device 412 that transition a telescoping probe member of the remote imaging device 402 between the stowed configuration and an extended configuration, e.g., as shown in FIGS. 5A-6F. The ECU 404 may apply the one or more linear control signals in response to a first activation signal from a computing device (e.g., the autonomy computing system 200 and/or the backend server 406) associated with the autonomous vehicle 100.

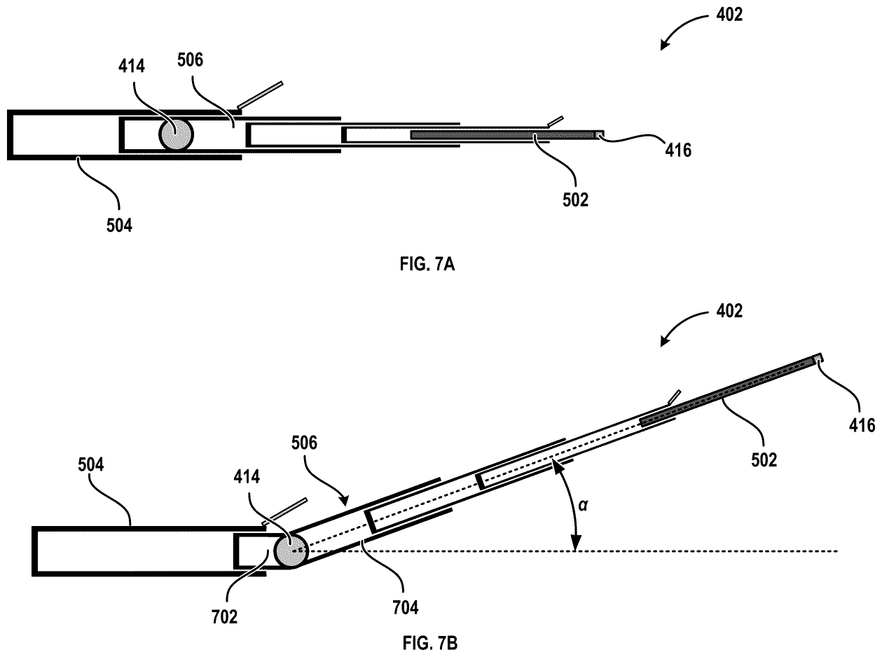

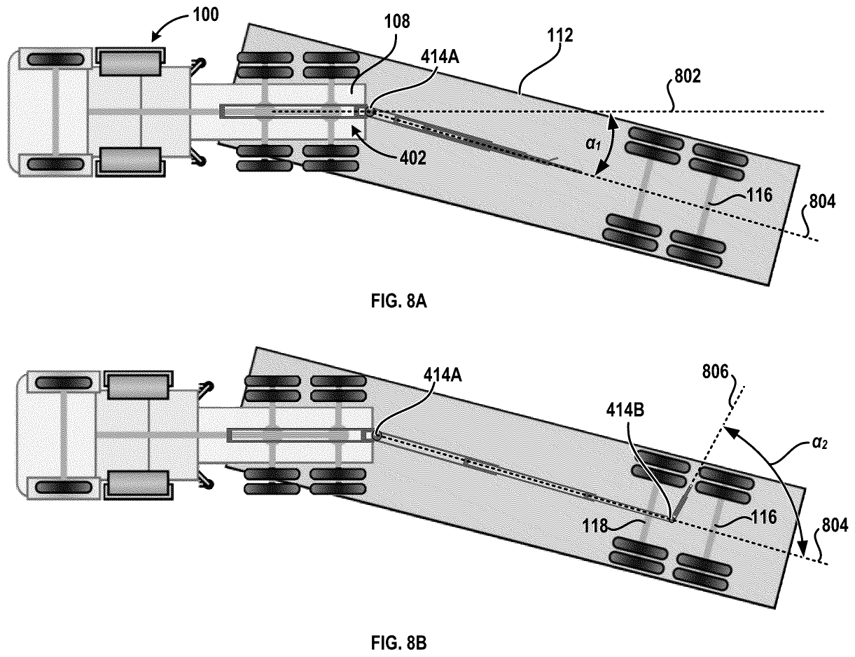

Likewise, the ECU 404 can generate or otherwise apply one or more rotational control signals to the rotational actuator device 414 that rotates the distal portion of the telescoping probe member between a first extended configuration and a second extended configuration, e.g., as shown in FIGS. 7A-8B. The ECU 404 may apply the one or more rotational control signals responsive to a second activation signal from a computing device (e.g., the autonomy computing system 200 and/or the backend server 406) associated with the autonomous vehicle 100.

Further, the ECU 404 can generate or otherwise apply one or more sensor control signals to the sensor device 416 to control aspects of the sensor device 416 such as image capture. Other aspects of the sensor device 416 that may be controlled through the one or more sensor control signals can include on/off state, calibration, focus/angle/lens adjustment, a mode, and the like. The ECU 404 may apply the one or more sensor control signals in response to a third activation signal from a computing device (e.g., the autonomy computing system 200 and/or the backend server 406) associated with the autonomous vehicle 100. The ECU 404 may also receive image data (e.g., as video data, keyframes, still images, thermal imaging data, etc.) of the volume of interest captured by the sensor device 416, and may communicate the image data to the computing device associated with the autonomous vehicle 100. The sensor device 416 may be configured as a wide-angle (“fisheye”) lens to ensure maximum visibility. In some examples, the ECU 404 may also apply illuminator control signals to illuminator device(s) 418 that can be positioned along the remote imaging device 402; illuminator device(s) 418 may be controlled to ensure similar lighting conditions between image capture sessions.

FIGS. 5A-5C show an example embodiment of the remote imaging device 402 of the remote imaging system 400; and FIGS. 6A-6F show the remote imaging device 402 in context with the autonomous vehicle 100. The remote imaging device 402 can include a telescoping probe member 500 in operative communication with a control device (e.g., ECU 404). The telescoping probe member 500 can include a proximal portion coupled to a rear portion 108 of the autonomous vehicle 100, and a distal portion having the sensor device 416 operable to capture imaging data for a volume of interest underneath a trailer (e.g., trailer 110) when the trailer is coupled to the rear portion 108 of the autonomous vehicle 100. Importantly, the distal portion of the telescoping probe member 500 is movable between a stowed configuration (FIGS. 5A, 6A, and 6B) and an extended configuration (FIGS. 5C, 6E, and 6F) by the linear actuator device 412 in operative communication with the control device. FIGS. 5B, 6C, and 6D show an intermediate or “partially extended” configuration.

The telescoping probe member 500 can include a probe section 502 having a distal portion carrying the sensor device 416, as well as a telescoping section (denoted as telescoping section 520 in FIG. 5C) that can transition between the stowed configuration and one or more extended configurations (such as the partially-extended and fully-extended configurations respectively shown in FIGS. 5B and 5C) by the linear actuator device 412. The telescoping section can include one or more encapsulating lumens (e.g., an exterior encapsulating lumen 504, one or more one or more intermediate encapsulating lumen(s) 506, and an interior encapsulating lumen 508) at least partially encapsulating the probe section 502, as shown in FIGS. 5A-5C. In some examples, the telescoping probe member 500 can include one or more illuminator devices 418 positioned along its length to illuminate the volume of interest.

When in the “stowed” configuration, shown in FIGS. 5A, 6A, and 6B, the one or more encapsulating lumens of the telescoping section can fully encapsulate the probe section 502. The one or more encapsulating lumens define a coaxially nested arrangement with one another and the probe section 502 when in the stowed configuration. When in an “extended” configuration as in FIG. 5B (and FIGS. 6C, 6D) and 5C (and FIGS. 6E, 6F), the distal portion of the probe section 502 extends from the telescoping section (e.g., telescoping section 520 as labeled in FIG. 5C).

In certain embodiments, the telescoping section 520 can include an exterior encapsulating lumen 504 having a proximal portion that is coupled to the rear portion 108 (of the truck bed 104) of the autonomous vehicle 100. The exterior encapsulating lumen 504 can remain at the rear portion 108 of the autonomous vehicle 100; the probe section 502 can move relative to the exterior encapsulating lumen 504 and may be fully encapsulated within the exterior encapsulating lumen 504 when in the stowed configuration of FIG. 5A.

Further, the telescoping section 520 can include an interior encapsulating lumen 508 (e.g., as an inner-most encapsulating lumen of the one or more encapsulating lumens) which can at least partially encapsulate a proximal portion of the probe section 502 when in an extended configuration as in FIGS. 5B and 5C, and can fully encapsulate the probe section 502 when in the stowed configuration.

The telescoping section 520 may also include one or more intermediate encapsulating lumen(s) 506. The example of FIGS. 5A-5C shows two intermediate encapsulating lumen(s), e.g., a first intermediate encapsulating lumen 506A (outer-most) and a second intermediate encapsulating lumen 506B (inner-most). In certain embodiments, the exterior encapsulating lumen 504 at least partially encapsulates the first intermediate encapsulating lumen 506A, which at least partially encapsulates the second intermediate encapsulating lumen 506B, which at least partially encapsulates the interior encapsulating lumen 508, which at least partially encapsulates the probe section 502.

Note that there may be other examples where only one intermediate encapsulating lumen may be included, or none. There may also be examples that do not include an interior encapsulating lumen; in such examples, the exterior encapsulating lumen can at least partially encapsulate a proximal portion of the probe section when in an extended configuration, and can fully encapsulate the probe section when in the stowed configuration.

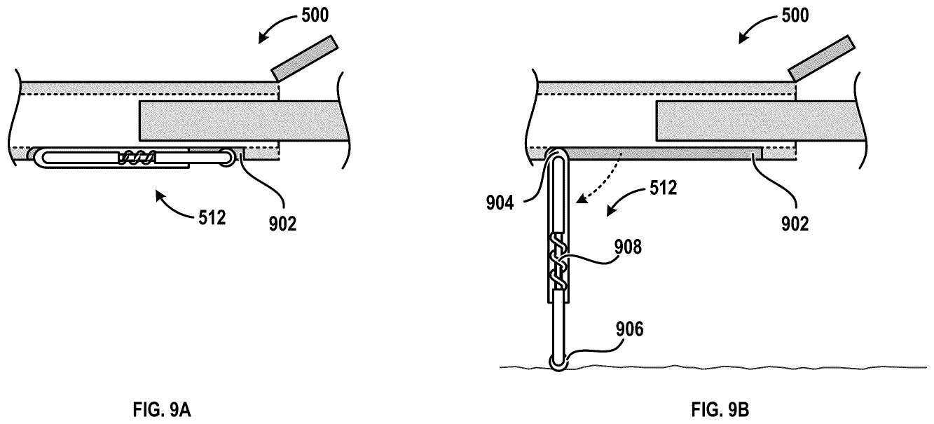

As outlined in further detail herein and as shown in FIG. 5C, the remote imaging device 402 can include a support member 512 that can extend from the telescoping probe member 500 along a downward vertical direction to contact a ground surface underneath the telescoping probe member 500 when the telescoping probe member 500 is in the extended configuration. The support member 512 is described below with respect to FIGS. 9A and 9B.

As further shown, the remote imaging device 402 can include one or more protective caps enclosing the probe section 502 and/or any encapsulating lumen(s) captured within the exterior encapsulating lumen 504. In the example of FIGS. 5A-5C, a first protective cap 510A is positioned at a distal portion of the interior encapsulating lumen 508 to protect the probe section 502 (which holds the sensor device 416). The first protective cap 510A can transition between a “closed” state and an “open” state when the telescoping probe member 500 transitions between the stowed configuration and an extended configuration. The example of FIGS. 5A-5C also shows a second protective cap 510B positioned at a distal portion of the exterior encapsulating lumen 504 to protect the rest of the telescoping probe member 500, including the probe section 502 and sensor device 416 and any additional encapsulating lumens (e.g., intermediate and/or interior encapsulating lumens) and associated components. Likewise, the second protective cap 510B can transition between a “closed” state and an “open” state when the telescoping probe member 500 transitions between the stowed configuration and an extended configuration. Transitioning of the one or more protective caps may be achieved using individual or otherwise dedicated actuator devices (e.g., separate from the actuator devices which transition the telescoping probe member 500 between the stowed configuration and an extended configuration), or may be achieved in a coupled motion using the same linear actuator device(s) 412, which transition the telescoping probe member 500 between the stowed configuration and an extended configuration.

Arrangements of the linear actuator device 412 and the telescoping probe member 500 may incorporate, for example, a lead screw or threaded lumen arrangement, a pneumatic arrangement, a cable-driven arrangement, a rack-and-gear arrangement, and the like.

FIGS. 6A and 6B respectively show a first diagram 600A and a second diagram 600B of the remote imaging device 402 in context with the autonomous vehicle 100 and trailer 110 in the stowed configuration, where the first diagram 600A shows a side view and the second diagram 600B shows a bottom view. As shown, the remote imaging device 402 is coupled along the rear portion 108 of the truck bed 104, underneath the trailer body 112.

FIGS. 6C and 6D respectively show a third diagram 600C and a fourth diagram 600D of the remote imaging device 402 in context with the autonomous vehicle 100 and trailer 110 in a (partially) extended configuration, where the third diagram 600C shows a side view and the fourth diagram 600D shows a bottom view. As shown, the telescoping probe member 500 of the remote imaging device 402 extends from the rear portion 108 of the truck bed 104 to position the sensor device 416 towards a rear portion of the trailer body 112 (but not quite reaching the rear axle 116). The exterior encapsulating lumen remains positioned at the rear portion 108 of the truck bed 104.

FIGS. 6E and 6F respectively show a fifth diagram 600E and a sixth diagram 600F of the remote imaging device 402 in context with the autonomous vehicle 100 and trailer 110 in a (fully) extended configuration, where the fifth diagram 600E shows a side view and the sixth diagram 600F shows a bottom view. As shown, the telescoping probe member 500 of the remote imaging device 402 extends from the rear portion 108 of the truck bed 104 to position the sensor device 416 towards a rear portion of the trailer body 112 and past the rear axle 116. The exterior encapsulating lumen remains positioned at the rear portion 108 of the truck bed 104. The support member 512 is shown contacting the ground in an extended position to support the distal portion of the telescoping probe member 500.

As shown in FIGS. 7A-8B, the remote imaging device 402 can be operable for further articulation between a plurality of extended configurations at varying degrees of rotation. FIGS. 7A and 7B show first and second images of the remote imaging device 402 including the rotational actuator device 414 enabling rotation of one or more “segments” of the telescoping probe member relative to one another. In the example, the rotational actuator device 414 is associated with intermediate encapsulating lumen 506, which is at least partially encapsulated by the exterior encapsulating lumen 504. When extended past a distal portion of the exterior encapsulating lumen 504 as in FIG. 7B, the rotational actuator device 414 can rotate at least a portion of intermediate encapsulating lumen 506 (as well as subsequent segments of the telescoping probe member including any subsequent intermediate encapsulating lumens, the interior encapsulating lumen, and the probe section 502 including the sensor device 416) relative to a direction of elongation of the exterior encapsulating lumen 504 to a specified rotation angle, e.g., rotation angle α. In the example of FIG. 7B, the intermediate encapsulating lumen 506 associated with the rotational actuator device 414 can be divided into a first segment 702, which remains anchored within the exterior encapsulating lumen 504, and a second segment 704, which can at least partially encapsulate a subsequent segment of the telescoping probe member as shown. An angle between the first segment 702 and the second segment 704 can be the specified rotation angle, pivoting around the rotational actuator device 414.

FIG. 8A shows an example similar to FIG. 7B but in context with the autonomous vehicle 100 and trailer body 112, where a first rotational actuator device 414A rotates a portion of the remote imaging device 402 relative to a midline 802 of the autonomous vehicle 100 (more specifically, a midline 802 of the exterior encapsulating lumen 504). As shown, a portion of the telescoping probe member of the remote imaging device 402 that is distal to the first rotational actuator device 414A follows a first line 804, defining a first rotation angle α₁ relative to the midline 802. This rotation aspect may be useful when, for example, the trailer body 112 is positioned at an angle relative to the cabin of the autonomous vehicle 100 as shown. The ECU (e.g., ECU 404 of FIG. 4B) can apply one or more rotational control signals to the first rotational actuator device 414A that rotates a portion of the telescoping probe member between a first extended configuration (e.g., as shown in FIG. 6F) and a second extended configuration as in FIG. 8A. The rotational control signals can specify a rotation angle, e.g., first rotation angle α₁, which can be selected based on direct controls from the autonomy computing system or backend server; in some examples, for ease of departure check, the autonomy computing system or backend server may sense and specify a rotation angle that directly correlates with an angle of the trailer body 112 relative to the cabin of the autonomous vehicle 100. The rotation angle may also be set to another value to better view any other area underneath or lateral to the trailer body.

FIG. 8B shows another example further including a second rotational actuator device 414B of the remote imaging device 402, where the second rotational actuator device 414B can be associated with an interior encapsulating lumen for articulating a distal-most segment (i.e., the probe member with sensor device) of the telescoping member relative to one or more preceding segment(s). In the example, the second rotational actuator device 414B rotates the distal-most segment to follow a second line 806, defining a second rotation angle α₂ relative to the first line 804. This allows, for example, the remote imaging device 402 to position the sensor device in hard-to-see areas such as between a first set of tires associated with a (distal-most) rear axle 116 of the trailer and a second set of tires associated with a proximal-most rear axle 118 of the trailer. The ECU (e.g., ECU 404 of FIG. 4B) can apply one or more rotational control signals to the second rotational actuator device 414B that rotates a portion of the telescoping probe member between a first extended configuration (e.g., as shown in FIG. 6F, or as shown in FIG. 8A) and a second extended configuration as in FIG. 8B. The rotational control signals can specify a rotation angle, e.g., second rotation angle α₂, that can be selected based on direct controls from the autonomy computing system or backend server; in some examples, for ease of departure check, the autonomy computing system or backend server may sense and specify a rotation angle that directly correlates with a known position of the axles and/or tires of the trailer. The rotation angle may also be set to another value to better view any other area underneath or lateral to the trailer body. Further, while FIG. 8B shows two example rotational actuators at specific positions along the telescoping probe member, other examples are contemplated including additional rotational actuators to add further degrees of articulation of the telescoping probe member, and/or alternative positions of rotational actuators along the length of the telescoping probe member.

FIGS. 9A and 9B show the support member 512 extendable from the telescoping probe member 500 along a downward vertical direction to contact a ground surface underneath the telescoping probe member 500 when the telescoping probe member 500 is in the extended configuration (see FIGS. 5C, 6E, and 6F). FIG. 9A shows an example where the support member 512 is stowed within a support member receptacle 902 of the telescoping probe member 500. FIG. 9B shows a deployed position of the support member 512, which can pivot around a pivot point 904 to position a support member element 906 of the support member 512 towards a ground surface to prevent the telescoping probe member 500 from buckling under force. The support member 512 can include shock absorption elements 908 that can flexibly accommodate variations in ground surface height and texture, e.g., to traverse gravel or uneven pavement. The support member element 906 can be in the form of a wheel, a skid plate, and the like. The support member 512 can likewise be actuated by a dedicated actuator motor, and/or may be deployed passively, e.g., may be tied to extension of the telescoping probe member 500 by the linear actuator device(s) 412.

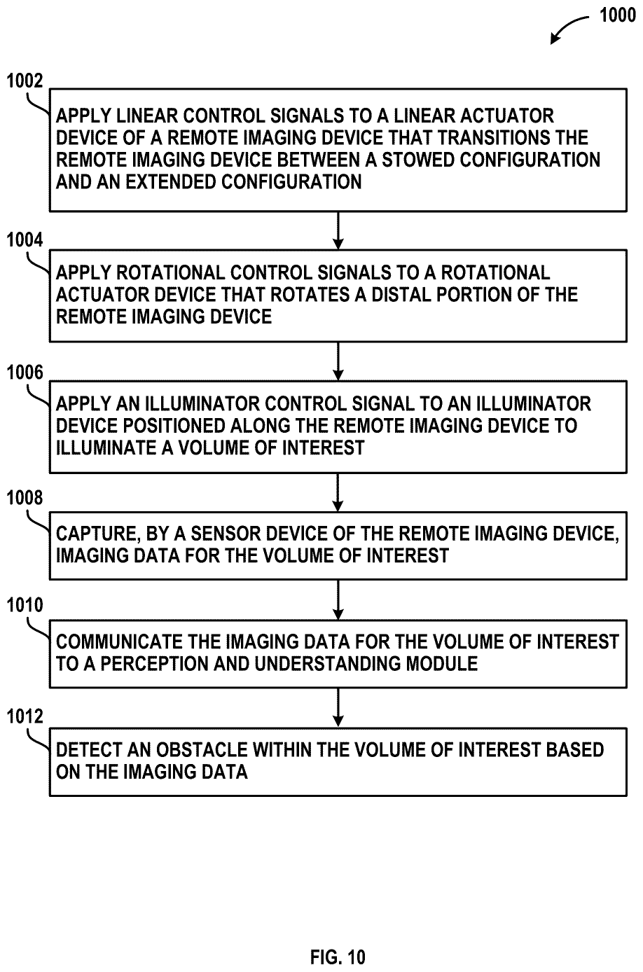

FIG. 10 is a flow diagram of a method 1000 of conducting a pre-departure check of a volume-of-interest for an autonomous vehicle using the remote imaging device (e.g., remote imaging device 402 and associated components as shown in FIGS. 4A-9B).

Method 1000 includes applying 1002, by a computing device of an autonomous vehicle, such as autonomy computing system 200 of autonomous vehicle 100, one or more linear control signals to a linear actuator device (e.g., linear actuator device 412) of a remote imaging device (e.g., remote imaging device 402) that transitions a telescoping probe member, such as telescoping probe member 500 of the remote imaging device 402, between a stowed configuration and an extended configuration. The remote imaging device includes an exterior encapsulating lumen (e.g., exterior encapsulating lumen 504) coupled to a rear portion of the autonomous vehicle; a sensor device (such as sensor device 416 of probe section 502 of telescoping probe member 500) is positioned within the exterior encapsulating lumen when in the stowed configuration and is positioned behind a rear axle of a trailer (e.g., trailer 110) when in the extended configuration.

Method 1000 can include applying 1004, by the computing device, one or more rotational control signals to a rotational actuator device (e.g., rotational actuator device 414) of the remote imaging device that rotates a distal portion of the remote imaging device between a first extended configuration and a second extended configuration. In some examples, the computing device can specify a particular rotation angle relative to a previous configuration, midline of the autonomous vehicle, or another value that results in a targeted angle. For example, the computing device may be able to measure an angle of the trailer relative to the midline of the autonomous vehicle 100, and may instruct the rotational actuator device to rotate the distal portion of the remote imaging device to a second extended configuration that aligns with the angle of a trailer. In other examples, the computing device can apply one or more rotational control signals to a rotational actuator device that is associated with the distal portion of the remote imaging device (e.g., as in rotational actuator device 414B of FIG. 8B) to transition the remote imaging device to the second extended configuration that positions the sensor device between two or more tires of the trailer.

Method 1000 can include applying 1006, by the computing device, an illuminator control signal to an illuminator device (e.g., illuminator device 418) positioned along the remote imaging device to illuminate the volume of interest during capture of the imaging data. In some examples, the illuminator control signal applied to the illuminator device(s) may specify brightness and color temperature to ensure similar or otherwise optimized lighting conditions between image capture sessions.

Method 1000 includes capturing 1008, by a sensor device positioned at a distal portion of the telescoping probe member (such as sensor device 416), imaging data for a volume of interest underneath the trailer coupled to the autonomous vehicle. The imaging data may include video or still-image data, and may also include thermal data. The imaging data can be captured during the step of transitioning the telescoping probe member of the remote imaging device between a stowed configuration and an extended configuration.

Method 1000 includes communicating 1010 the imaging data for the volume of interest to a perception and understanding module (e.g., perception and understanding module 236) of the autonomy computing system of the autonomous vehicle (and/or to a backend server such as backend server 406 in communication with the autonomous vehicle 100) for processing.

Method 1000 includes detecting 1012, at the perception and understanding module of the autonomy computing system (and/or the backend server), an obstacle within the volume of interest based on the imaging data. Based on the presence (or absence) of an obstacle, the autonomous vehicle may or may not depart. If an obstacle is detected, the autonomous vehicle may request further assistance or instructions from the backend server or from a human associated with the backend server.

While method 1000 is discussed in terms of conducting a pre-departure check (e.g., looking for pedestrians, vehicles, children, curbs), method 1000 can also be similarly applied or adapted for use in situations where the autonomous vehicle needs to pull over and check for problems (e.g., dragging chains, tire pressure or blowout issues, tampering, road debris, etc.). While imaging data captured in these example situations may or may not show obstacles, the imaging data can elucidate the autonomous vehicle and associated decision makers about potential issues through, e.g., thermal data, visual comparison between a current state of the volume of interest and a previous state of the volume of interest (e.g., whether something fell off, got stuck, or is otherwise broken), etc.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) visual inspection and interpretation of information about a volume of interest below a trailer; (b) enabling a departure check within a volume of interest for safety assurance and compliance with laws; and/or (c) enabling an autonomous vehicle to pull over and check for problems when not at a hub (such as dragging chains, tire pressure or blowout issues, tampering, road debris, and the like).

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more machine executable instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. A remote imaging device, comprising:
a telescoping probe member in operative communication with a control device, the telescoping probe member including:
a proximal portion coupled to a rear portion of an autonomous vehicle; and
a distal portion having a sensor device operable to capture imaging data for a volume of interest underneath a trailer when the trailer is coupled to the rear portion of the autonomous vehicle;
wherein the distal portion of the telescoping probe member is movable between a stowed configuration and an extended configuration by a linear actuator device in operative communication with the control device.

2. The remote imaging device of claim 1, the control device including a processor in communication with a memory, the memory including instructions executable by the processor to:
access a first activation signal from a computing device associated with the autonomous vehicle; and
apply, responsive to the first activation signal, one or more linear control signals to the linear actuator device that transitions the telescoping probe member between the stowed configuration and the extended configuration.

3. The remote imaging device of claim 1, the extended configuration being one of a plurality of extended configurations, and the telescoping probe member further comprising:
a rotational actuator device in operative communication with the control device that rotates the distal portion of the telescoping probe member between a first extended configuration of the plurality of extended configurations and a second extended configuration of the plurality of extended configurations relative to a midline of the autonomous vehicle.

4. The remote imaging device of claim 3, the control device including a processor in communication with a memory, the memory including instructions executable by the processor to:
access a second activation signal from a computing device associated with the autonomous vehicle; and
apply, responsive to the second activation signal, one or more rotational control signals to the rotational actuator device that rotates the distal portion of the telescoping probe member between the first extended configuration and the second extended configuration.

5. The remote imaging device of claim 1, the control device including a processor in communication with a memory, the memory including instructions executable by the processor to:
access a third activation signal from a computing device associated with the autonomous vehicle;
apply, responsive to the third activation signal, an image capture signal to the sensor device; and
communicate the imaging data from the sensor device to the computing device of the autonomous vehicle.

6. The remote imaging device of claim 1, the telescoping probe member further comprising:
a support member that extends from the telescoping probe member along a downward vertical direction to contact a ground surface underneath the telescoping probe member when the telescoping probe member is in the extended configuration.

7. The remote imaging device of claim 1, the telescoping probe member including:
a telescoping section having one or more encapsulating lumens including an exterior encapsulating lumen, the exterior encapsulating lumen including a proximal portion that is coupled to the rear portion of the autonomous vehicle; and
a probe section having a proximal portion that is at least partially encapsulated within the one or more encapsulating lumens, and a distal portion having the sensor device;
each encapsulating lumen of the one or more encapsulating lumens defining a coaxially nested arrangement with one another and the probe section when in the stowed configuration; and
the distal portion of the probe section extending from the telescoping section when in the extended configuration.

8. The remote imaging device of claim 7, the linear actuator device being operable to actuate the probe section between the stowed configuration and the extended configuration relative to the exterior encapsulating lumen.

9. The remote imaging device of claim 7, the one or more encapsulating lumens including an interior encapsulating lumen that is at least partially encapsulated within the exterior encapsulating lumen.

10. A method of conducting a pre-departure check of a volume of interest, comprising:
applying, by a computing device of an autonomous vehicle, one or more linear control signals to a linear actuator device of a remote imaging device that transitions a telescoping probe member of the remote imaging device between a stowed configuration and an extended configuration;
capturing, by a sensor device positioned at a distal portion of the telescoping probe member, imaging data for a volume of interest underneath a trailer coupled to the autonomous vehicle; and
communicating the imaging data for the volume of interest to a perception and understanding module of an autonomy computing system of the autonomous vehicle.

11. The method of claim 10, the sensor device being positioned behind a rear axle of the trailer when in the extended configuration.

12. The method of claim 10, the remote imaging device having an exterior encapsulating lumen coupled to a rear portion of the autonomous vehicle, and the sensor device being positioned within the exterior encapsulating lumen when in the stowed configuration.

13. The method of claim 10, further comprising:
applying, by the computing device, one or more rotational control signals to a rotational actuator device of the remote imaging device that rotates a distal portion of the remote imaging device between a first extended configuration and a second extended configuration.

14. The method of claim 13, the sensor device being positioned between two or more tires of the trailer when in the second extended configuration.

15. The method of claim 10, further comprising:
detecting, at the perception and understanding module of an autonomy computing system, an obstacle within the volume of interest based on the imaging data.

16. The method of claim 10, further comprising:
communicating the imaging data for the volume of interest to a backend server in communication with the autonomous vehicle.

17. The method of claim 10, further comprising:
applying an illuminator control signal to an illuminator device positioned along the remote imaging device to illuminate the volume of interest during capture of the imaging data.

18. A computing system of an autonomous vehicle, comprising:
a processor in communication with a memory, the memory including instructions executable by the processor to:
apply one or more linear control signals to a linear actuator device of a remote imaging device that transitions a telescoping probe member of the remote imaging device between a stowed configuration and an extended configuration, the remote imaging device having an exterior encapsulating lumen coupled to a rear portion of the autonomous vehicle;
capture, by a sensor device positioned at a distal portion of the telescoping probe member, imaging data for a volume of interest underneath a trailer coupled to an autonomous vehicle; and
communicate the imaging data for the volume of interest to a perception and understanding module of an autonomy computing system of the autonomous vehicle.

19. The computing system of claim 18, the memory further including instructions executable by the processor to:
apply one or more rotational control signals to a rotational actuator device of the remote imaging device that rotates a distal portion of the remote imaging device between a first extended configuration and a second extended configuration, the sensor device being positioned between two or more tires of the trailer when in the second extended configuration.

20. The computing system of claim 18, the memory further including instructions executable by the processor to:
detect, at the perception and understanding module of an autonomy computing system, an obstacle within the volume of interest based on the imaging data.
